(19) United States
(12) Patent Application Publication
(10) Pub. No.: US 2002/0011734 A1
(43) Pub. Date: Jan. 31, 2002

(54) Single use lock

(76) Inventor: George F. Pickett, Maumee, OH (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 09/838,405

(22) Filed: Apr. 19, 2001

Related U.S. Application Data
(60) Provisional application No. 60/198,543, filed on Apr. 19, 2000.

(51) Int. Cl. G09F 3/03

(52) U.S. Cl. 292/319

(57) ABSTRACT

A locking apparatus includes a lock ring having a least one straight portion terminating in a free end and at least one lock body having a lock ring aperture formed therethrough for receiving the lock ring straight portion. The lock ring aperture terminates at one end in an enlarged recess wherein at least one snap ring is maintained in the retaining recess. The snap ring has a central aperture defining an inner periphery. When the straight portion is inserted through the lock ring aperture and through the central aperture, the inner periphery of the snap ring engages in outer surface of the straight portion requiring an application of force exceeding a predetermined amount to separate the lock ring from the lock body and the snap ring.

### CROSS REFERENCED TO RELATED APPLICATION

This application is a completion application of a co-pending U.S. Provisional Patent Application Serial No. 60/198,543, filed Apr. 19, 2000, entitled “SINGLE USE LOCK”, the disclosure of which is hereby incorporated by reference.

### BACKGROUND OF THE INVENTION

The present invention relates to padlocks and, more particularly, to single use locks for locking electric utility enclosures.

Generally, padlocks include a housing or body, a shackle and a locking mechanism contained within the housing. The shackle is inserted through the articles to be locked together, such as a latch or through the links of a chain, and is engaged by a locking mechanism to hold the shackle in the housing. Padlocks are usually removable, that is the locking mechanism can be locked and then unlocked utilizing a key or combination to release the shackle. After release of the shackle the lock can then be removed and used again by reactuating the locking mechanism.

In many circumstances, it is not necessary to frequently access a locked cabinet or enclosure. For example, an electric utility company may store electrical power distribution equipment located in cabinets or enclosures in remote locations. These enclosures are not frequently accessed but must be securely locked to prevent unwanted tampering and damage. In such circumstances, a single use lock may be utilized to prevent unwanted access to the cabinet or enclosure.

Once the single use lock is engaged, the enclosure can only be unlocked after a predetermined force is applied to the lock, thereby destroying the lock in the process.

### SUMMARY OF THE INVENTION

The present invention concerns a single use locking apparatus that can be unlocked by applying a predetermined force to thereby destroy the locking apparatus. The locking apparatus includes: a lock ring having at least one straight portion terminating in a free end; at least one lock body having a lock ring aperture formed therethrough for receiving the lock ring straight portion, the lock ring aperture terminating at one end thereof and an enlarged retaining recess; and at least one snap ring being maintained in the retaining recess and having a central aperture defining an inner periphery.

When the straight portion is inserted through the lock ring aperture and through the central aperture, the inner periphery of the snap ring engages an outer surface of the straight portion requiring an application of force exceeding a predetermined amount to separate the lock ring from the lock body and the snap ring.

### BRIEF DESCRIPTION OF THE DRAWINGS

The above, as well as other advantages of the present invention, will become readily apparent to those skilled in the art from the following detailed description of which a preferred embodiment when considered in the light of the accompanying drawings in which:

FIG. 1 is a front elevational view of a single use locking apparatus in accordance with the present invention;

FIG. 2 is an enlarged cross sectional view of one of the lock bodies shown in FIG. 1; and

FIG. 3 is an enlarged plan view of the lock ring shown in FIG. 2.

### DETAILED DESCRIPTION OF THE PREFERRED EMBODIMENT

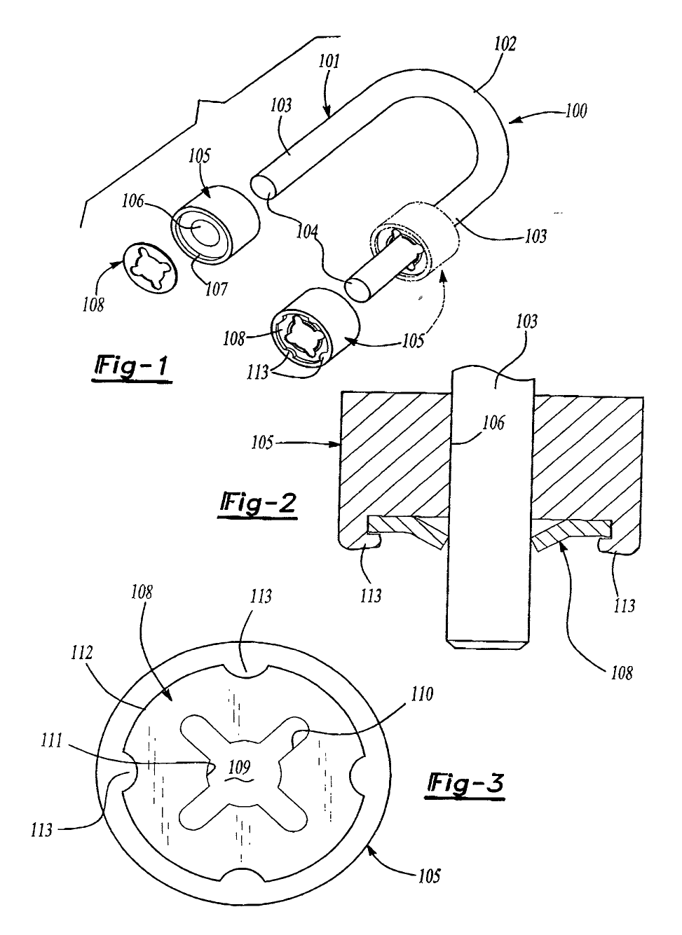

There is shown in FIG. 1 a single use locking apparatus (100) having a generally u-shaped lock ring (101) including a generally curved portion (102) connecting a pair of straight portions (103) extending generally parallel and terminating in free ends (104). A pair of lock bodies (105) is provided with each, and is attached to an associated one of the straight portions (103). Although the lock ring (101) depicted in FIG. 1 is generally u-shaped, the lock ring can be of any suitable shape, such as v-shaped or where the generally curved portion (102) defines in excess of one-half of a circle.

A cross sectional view of a lock body (105) of the present invention is depicted in FIG. 2. The body (105) may be of any suitable shape, such as a cylinder or cube, and has a lock ring aperture (106) formed therethrough for receiving the associated straight portion (103). The end portion of the aperture (106) is enlarged to form an annular retaining recess (107) in which a snap ring (108) is positioned.

As best depicted in FIG. 3, the snap ring (108) has a central aperture (109) with a plurality of cut-outs (110) extending from an inner periphery (111) at the central aperture toward an outer periphery (112) of the snap ring. The diameter of the central aperture (109) is slightly smaller than the outer diameter of the straight portion (103) and the interrupted inner periphery (112) forms a plurality of teeth that engage the surface of the straight portion.

The diameter of the snap ring (108) is slightly smaller than the diameter of the retaining recess (107) such that a portion of the lower end of the lock body is deformed inwardly at (113) to engage and maintain the snap ring (108) in the retaining recess (107). Typically, four of the inwardly deformed portions (113) are spaced equally about the retaining recess (107). Although four inwardly deformed portions (113) are typically utilized by the present invention, other numbers of inwardly deformed portions (113) such as 2,3,5 or 6 may be utilized by the present invention.

The snap ring (108) may be made of a hardened spring steel material while the lock ring (101) and the lock bodies (105) are preferably made of a softer aluminum material. This selection of materials allows for the plurality of teeth formed on the snap ring to engage the surface of the straight portion without failing as a force is applied. The use of a softer aluminum material in the lock body (105) also allows for easy formation of the inwardly deformed portions (113) of the lock body (105).

The lock body (105) and the snap ring (108) are preassembled by positioning the snap ring in the retaining recess (107) and forming the inwardly deformed portions (113). When it is desired to use the lock apparatus (100), the lock ring is passed through the openings of the structure to be locked, such as apertures or flanges that are attached to a pair of cabinet doors, and one of the preassembled lock body (105) and snap ring (108) assemblies is pushed onto each of the associated free ends (104) of the straight portions (103). As the lock body (105) is pushed onto the straight portion (103), the inner periphery (111), will deform downwardly. In use, one of the lock body (105) and snap ring (108) assemblies may be placed on the lock ring (101) before the lock ring is passed through an opening of the structure to be locked. Once the lock body (105) is positioned on the straight portion (103), if a subsequent force is applied to the lock body (105) toward the free end (104), the downwardly deformed inner periphery (111) will dig into the surface of the straight portion (103) thereby preventing removal of the lock body (105) until a predetermined force causing the above-relationship to fail is applied.

The present invention has been described in accordance with the relevant legal standards, thus the foregoing description is exemplary rather than limiting in nature. Variations and modifications to the disclosed embodiment may become apparent to those skilled in the art. Accordingly, the scope of legal protection afforded this invention can only be determined by studying the following claims.

What is claimed is:

1. A locking apparatus comprising:
a lock ring having a curved central portion and at least one straight portion terminating in a free end; and
at least one lock body having a lock ring aperture formed therethrough for receiving said lock ring straight portion, said lock ring aperture terminating at one end thereof in an enlarged retaining recess; and
at least one snap ring being maintained in said retaining recess and having a central aperture defining an inner periphery whereby when said straight portion is inserted through said lock ring aperture and through said central aperture, said inner periphery of said snap ring engages an outer surface of said straight portion requiring an application of force exceeding a predetermined amount to separate said lock ring from said lock body and said snap ring.

2. The locking apparatus of claim 1, wherein the at least one lock body further includes at least one inwardly deformed portion for maintaining the at least one snap ring in the enlarged retaining recess.

3. The locking apparatus of claim 2, wherein the at least one lock body includes four equidistantly spaced inwardly deformed portions for maintaining the at least one snap ring in the enlarged retaining recess.

4. The locking apparatus of claim 1, wherein a diameter of the central aperture of said retaining recess is smaller than an outer diameter of said straight portion.

5. The locking apparatus of claim 1, wherein the snap ring comprises hardened spring steel.

6. The locking apparatus of claim 1, wherein the lock ring comprises aluminum.

7. The locking apparatus of claim 1, wherein the lock body comprises aluminum.

8. The locking apparatus of claim 1, wherein the lock ring central portion is generally u-shaped.

9. The locking apparatus of claim 1, wherein the lock ring central portion is generally v-shaped.

10. The locking apparatus of claim 1, wherein the lock ring central portion defines in excess of one-half of a circle.

11. A locking apparatus comprising:
a lock ring having a curved central portion and at least one straight portion terminating in a free end; and
at least one lock body having a lock ring aperture formed therethrough for receiving said lock ring straight portion, said lock ring aperture terminating at one end thereof in an enlarged retaining recess; and
at least one snap ring and at least one inwardly deformed portion formed on said at least one lock body for maintaining said at least one snap ring in said at least one lock body and said at least one snap ring having a central aperture defining an inner periphery whereby when said straight portion is inserted through said lock ring aperture and through said central aperture, said inner periphery of said snap ring engages an outer surface of said straight portion requiring an application of force exceeding a predetermined amount to separate said lock ring from said lock body and said snap ring.
